(19) United States
(12) Patent Application Publication
(10) Pub. No.: US 2015/0291239 A1
(43) Pub. Date: Oct. 15, 2015

(54) ATTACHMENT MEMBER FOR BICYCLES

(71) Applicant: Wen-Sung Lee, Taichung City (TW)

(72) Inventor: Wen-Sung Lee, Taichung City (TW)

(21) Appl. No.: 14/252,788

(22) Filed: Apr. 15, 2014

(51) Int. Cl. B62J 6/00; F16B 2/22

(52) U.S. Cl. CPC B62J 6/00; F16B 2/22

(57) ABSTRACT

An attachment member for a bicycle includes an illumination portion, and two arms extend from the illumination portion. Each arm has a hole. At least one hooking member has a base part and a hook which is connected to the first end of the base part. The hook has a hooking room. An engaging portion extends from the base part and bent toward the second end of the base part. The engaging portion has an engaging room. The engaging portion is located between the first and second end of the base part. One of the two arms is engaged with the engaging room of the engaging portion, and the hook is hooked to the hole of the other arm to secure the attachment member to a bicycle frame. The engaging portion is released from the bicycle from by pushing the second end of the base part.

### BACKGROUND OF THE INVENTION

1. Fields of the invention

The present invention relates to an attachment member, and more particularly, to an attachment member for attaching accessories to a bicycle, and the attachment member is easily operated.

2. Descriptions of Related Art

The conventional safety equipment for a cyclist generally comprises a helmet, knee and elbow protection members, a bicycle suit and lights. The lights can be installed to the helmet and the bicycle frame so as to allow the drivers to see the cyclist and the bicycle in the dark area. The conventional attachment member for connecting a light to the bicycle frame generally comprises two parts which are connected to the bicycle frame by using a bolt, and the light is held on the two parts. The light is powered by a battery pack and controlled by a switch, both of which are connected to the attachment member. The bolt ensures that the attachment member is secured to the bicycle frame such as the head tube, the handlebar and/or the seat tube.

However, when installing the attachment member to the bicycle frame, the user needs to have a screwdriver to secure the bolt. When multiple attachment members are to be connected to the bicycle frame, the user takes a lot of time to secure the bolts one by one. The bolts have to be tightened evenly in order not to damage the bicycle frame. When adjusting the positions of the attachment members, the bolts have to be unscrewed and then tightened again. The conventional attachment members are not convenient to the users. Besides, the bolts are rusted after a period of time of use.

The present invention intends to provide an attachment member which is secured to the bicycle frame by using a hooking member so as to improve the shortcomings mentioned above.

### SUMMARY OF THE INVENTION

The present invention relates to an attachment member for a bicycle, and comprises an illumination portion located on the front end thereof. Two arms extend from the illumination portion and each arm has a hole. At least one hooking member has a base part and a hook which is connected to a first end of the base part. The hook extends from the first surface of the base part and is bent away from the base part. The hook has a hooking room. An engaging portion extends from the first surface of the base part and is bent toward the second end of the base part. The engaging portion has an engaging room. The engaging portion is located between the first and second ends of the base part. One of the two arms is engaged with the engaging room of the engaging portion, and the hook is hooked to the hole of the other arm.

Preferably, an entrance is formed between the distal end of the engaging portion and the second end of the main part. The entrance communicates with the engaging room.

Preferably, each of the two arms has a first portion and a second portion extending therefrom. An opening is formed between the first and second portions. The first and second portions of each of the arms are located corresponding to each other.

Preferably, each of the first and second portions has an aperture defined therethrough which communicates with the opening. Two of the hooking members are respectively connected to the two respective first portions of the two arms respectively by hooking the engaging portion to the aperture corresponding thereto. The two hooks of the two hooking members are respectively hooked to the two respective apertures of the two second portions.

Preferably, each of the first and second portions has an aperture defined therethrough which communicates with the opening. Two of the hooking members are respectively connected to the two respective second portions of the two arms respectively by hooking the engaging portion to the aperture corresponding thereto. The two hooks of the two hooking members are respectively hooked to the two respective apertures of the two first portions.

The primary object of the present invention is to provide an attachment member that is easily connected to the desired position of a bicycle frame by hooking the hooking member to the arm of the attachment member. The attachment member is easily removed from the bicycle frame by pushing the second end of the base part of the attachment member to disengage the engaging portion from the bicycle frame.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the attachment member of the present invention;

FIG. 2 is another perspective view to show the attachment member of the present invention;

FIG. 3 is an exploded view of the hooking member and the attachment member of the present invention;

FIG. 4 is a perspective view to show the hooking member of the present invention;

FIG. 5 is another perspective view to show the hooking member of the present invention;

FIG. 6 is a perspective view to show that the hooking member is not yet hooked to the other arm of the attachment member of the present invention;

FIG. 7 is a perspective view to show that the hooking member is hooked to the other arm of the attachment member of the present invention;

FIG. 8 is a perspective view to show that the attachment member of the present invention is connected to the bicycle;

FIG. 9 is an enlarged view to show that the attachment member of the present invention is connected to the bicycle;

FIG. 10 is a perspective view to show the second embodiment of the hooking member and the attachment member of the present invention;

FIG. 11 is another perspective view to show the second embodiment of the hooking member and the attachment member of the present invention, and

FIG. 12 shows the exploded view of the second embodiment of the hooking member and the attachment member of the present invention.

### DETAILED DESCRIPTION OF THE PREFERRED EMBODIMENT

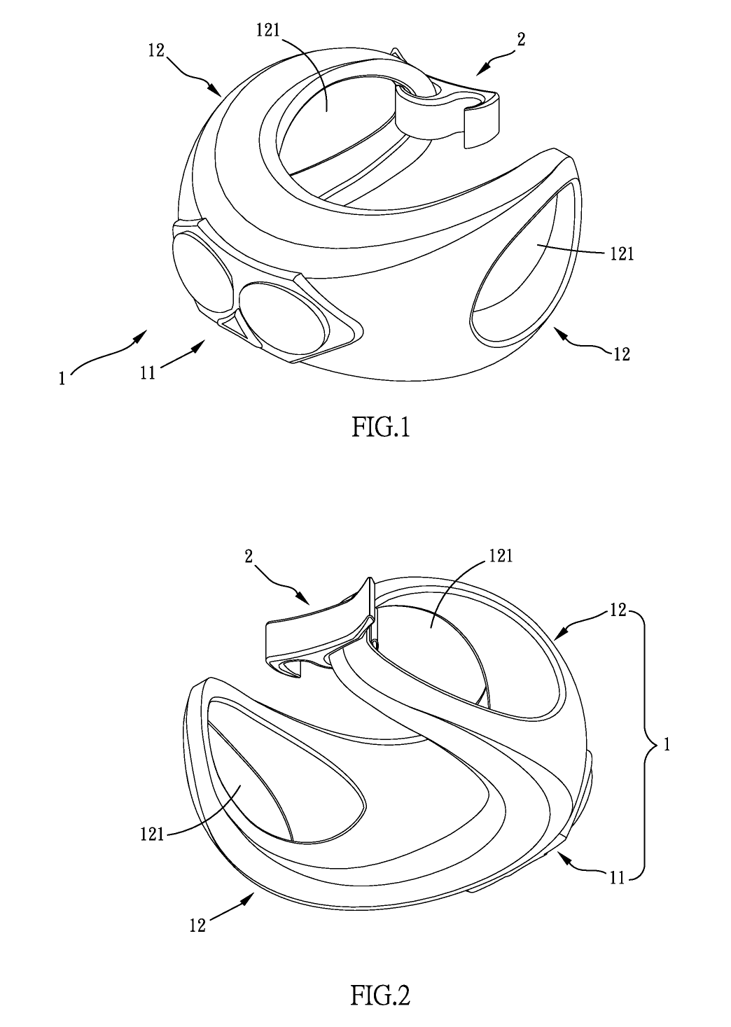

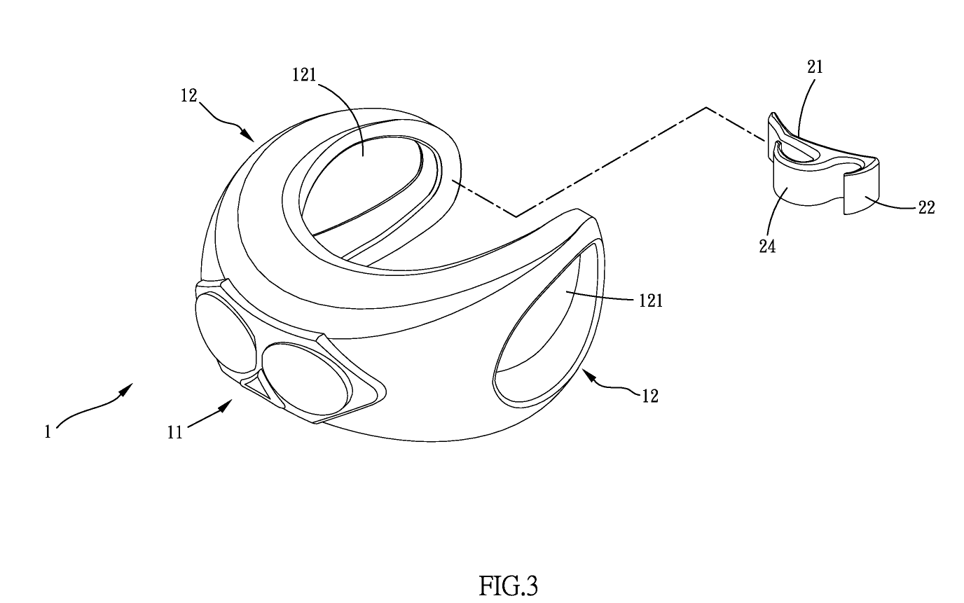

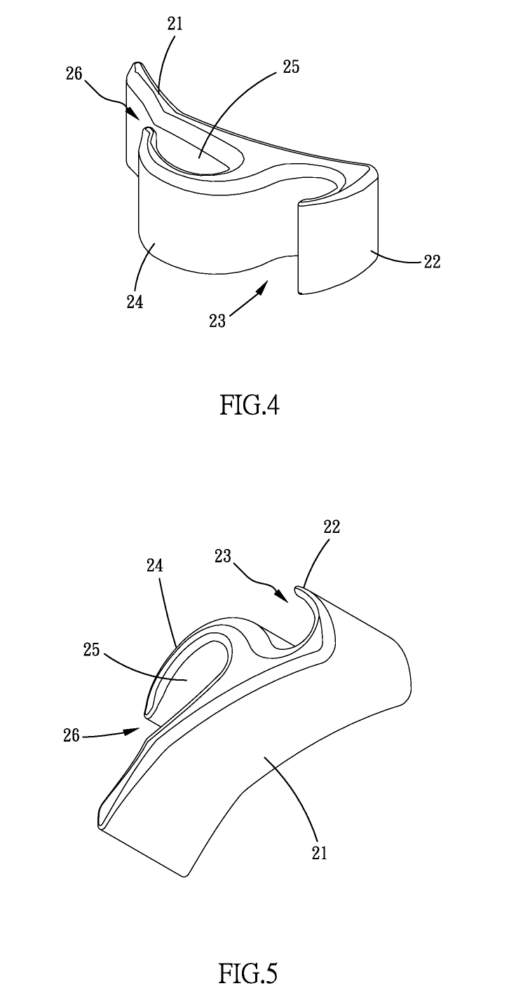

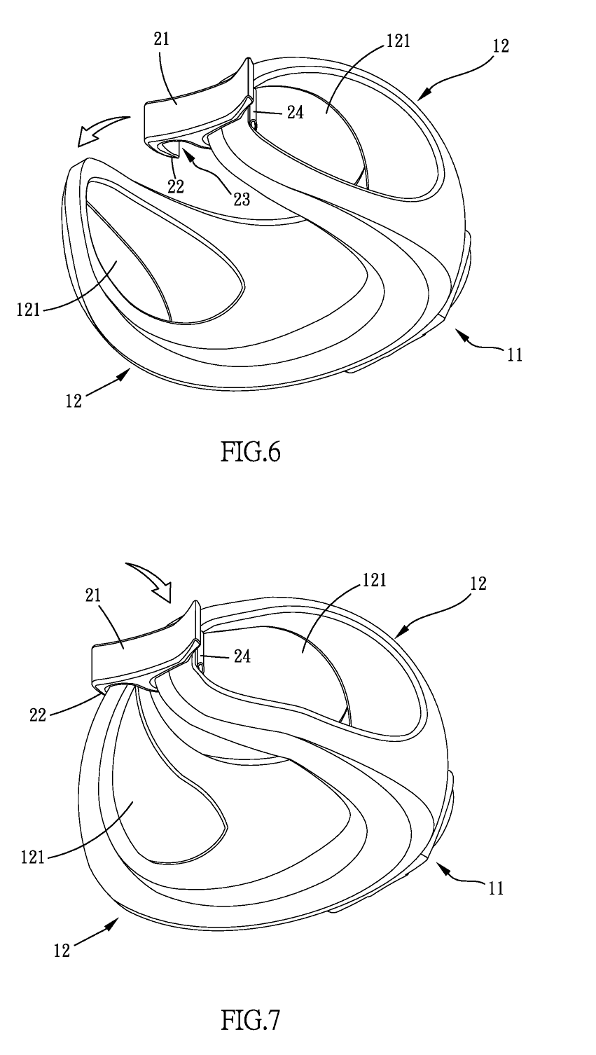

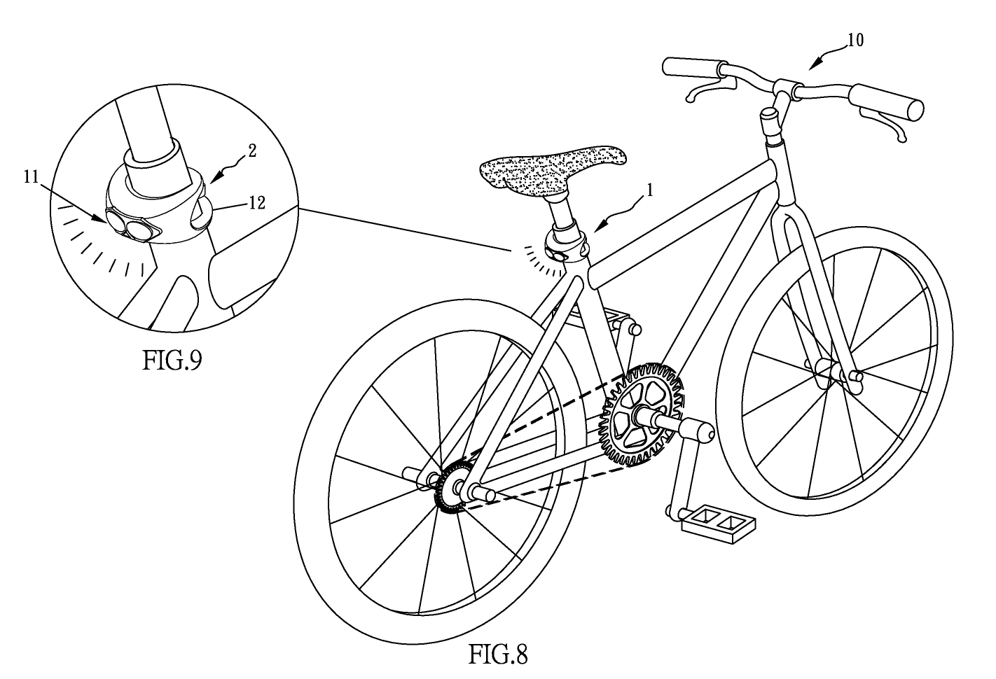

Referring to FIGS. 1 to 9, the attachment member of the present invention comprises an illumination portion 11 located on the front end thereof, and two flexible arms 12 extend from the illumination portion 11 and form a C-shaped attachment member. Each arm 12 has a hole 121.

A hooking member 2 has an elongate base part 21 and a hook 22 which is connected to the first end of the base part 21. The hook 22 extends from the first surface of the base part 21 and is bent away from the base part 21. The hook 22 has a hooking room 23. An engaging portion 24 extends from the first surface of the base part 21 and is bent toward the second end of the base part 21. The engaging portion 24 has an engaging room 25. The engaging portion 24 is located between the first and second ends of the base part 21. The engaging portion 24 of the hooking member 2 is hooked to the hole 121 of one of the two arms 12. The hook 22 is then hooked to the hole 121 of the other arm 12 to let the two arms 12 to warp to the tubular bicycle frame 10 such as the seat tube. The two arms 12 are flexible so that when hooking the hooking member 2 to the other arm 12, the flexibility of the arms 12 allows the user to easily pull the two arms 12 toward each other.

In detail, an entrance 26 is formed between the distal end of the engaging portion 24 and the second end of the main part 21. The entrance 26 communicates with the engaging room 25. When attaching the attaching member to the seat tube of the bicycle frame 10, the seat tube can be easily inserted into the engaging room 25 of the engaging portion 24 via the entrance 26. The user then pulls the two arms 12 around the seat tube, and the hook 22 of the hooking member 2 is then hooked to the hole 121 of the other arm 12.

When removing the attachment member from the seat tube of the bicycle frame 10, the user simply pushes the second end of the base part 21 away from the engaging portion 24, the entrance 26 becomes larger so that the seat tube of the bicycle frame 10 can be disengaged from the engaging portion 24. The second end of the base part 21 has a certain length and plays a role as a lever which is easily operated by the user.

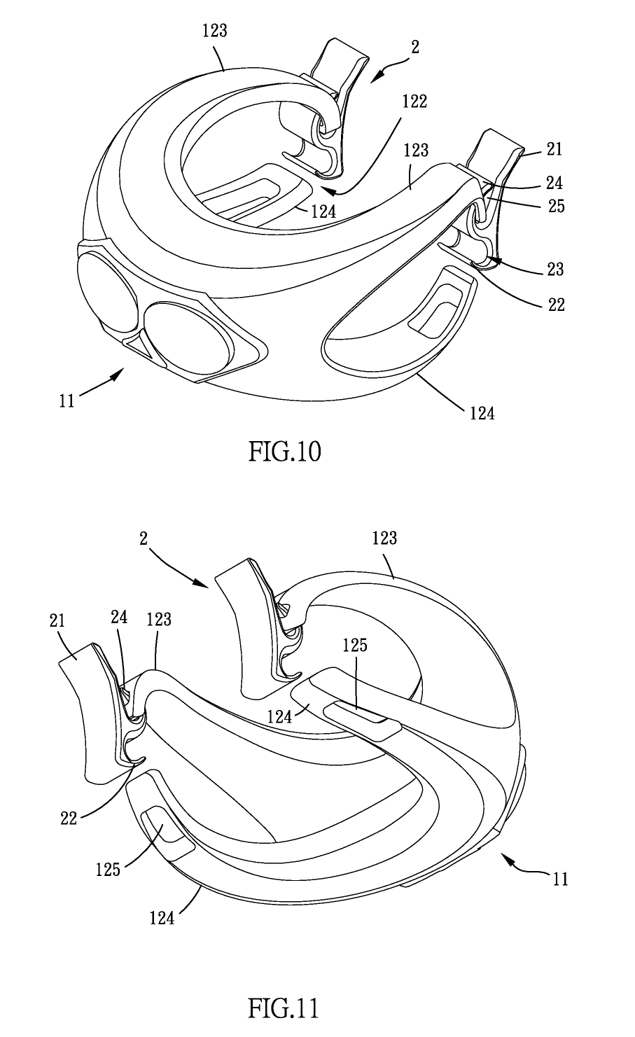

FIGS. 9 to 11 show the second embodiment of the present invention, wherein each of the two arms 12 has a first portion 123 and a second portion 124 extending therefrom to form like a fork. An opening 122 is formed between the first and second portions 123, 124. The first and second portions 123, 124 of each of the arms 12 are located corresponding to each other. Preferably, the first and second portions 123, 124 have the same length. Each of the first and second portions 123, 124 has an aperture 125 defined therethrough which communicates with the opening 122. In this embodiment, there are two hooking members 2 which are respectively connected to the two respective first portions 213 of the two arms 12 respectively by hooking the engaging portion 24 to the aperture 125 corresponding thereto. The two hooks 22 of the two hooking members 2 are respectively hooked to the two respective apertures 125 of the two second portions 124. In this embodiment, the first and second portions 123, 124 of each of the two arms 12 are connected to the bicycle frame 10. In other words, the two arms 12 are respectively connected to two positions of the bicycle frame 10.

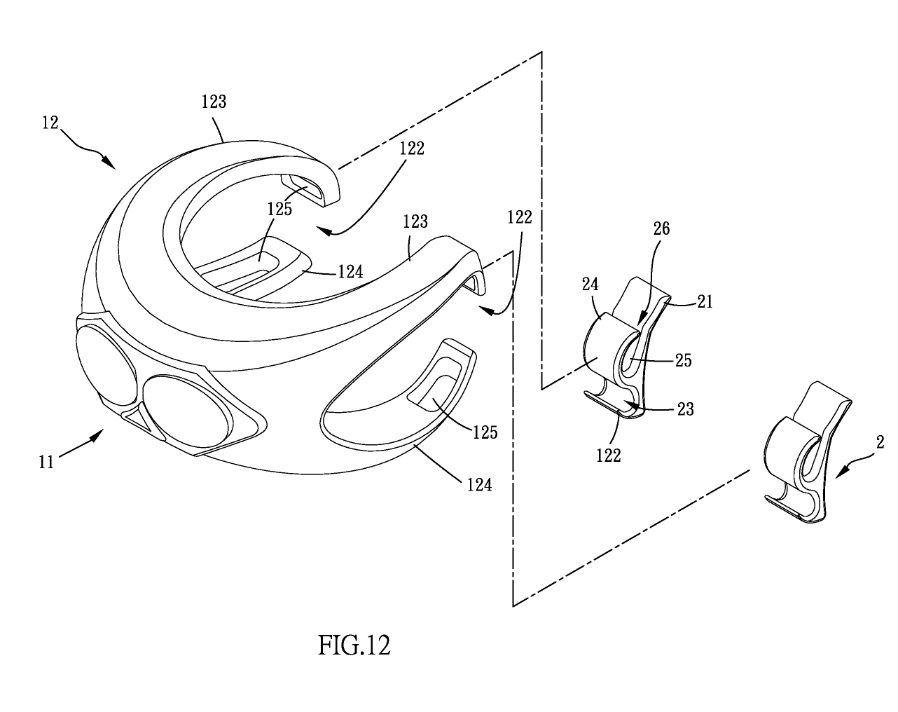

It is noted that the two hooking members 2 can also be respectively connected to the two respective second portions 214 of the two arms 12 respectively as shown in FIG. 12.

The present invention does not need any bolt and tool when installing the attachment member to the bicycle frame 10 or removing the attachment member from the bicycle frame 10

While we have shown and described the embodiment in accordance with the present invention, it should be clear to those skilled in the art that further embodiments may be made without departing from the scope of the present invention.

What is claimed is:

1. An attachment member 1 for a bicycle, comprising:
an illumination portion 11 located on a front end thereof, two arms 12 extending from the illumination portion 11 and each arm 12 having a hole 121, and
at least one hooking member 2 having a base part 21 and a hook 22 which is connected to a first end of the base part 21, the hook 22 extending from a first surface of the base part 21 and bent away from the base part 21, the hook 22 having a hooking room 23, an engaging portion 24 extending from the first surface of the base part 21 and bent toward a second end of the base part 21, the engaging portion 24 having an engaging room 25, the engaging portion 24 located between the first and second ends of the base part 21, one of the two arms 12 being engaged with the engaging room 25 of the engaging portion 24, the hook 22 being hooked to the hole 121 of the other arm 12.

2. The attachment member as claimed in claim 1, wherein an entrance 26 is formed between a distal end of the engaging portion 24 and the second end of the main part 21, the entrance 26 communicates with the engaging room 25.

3. The attachment member as claimed in claim 1, wherein each of the two arms 12 has a first portion 123 and a second portion 124 extending therefrom, an opening 122 is formed between the first and second portions 123, 124, the first and second portions 123, 124 of each of the arms 12 are located corresponding to each other.

4. The attachment member as claimed in claim 3, wherein each of the first and second portions 123, 124 has an aperture 125 defined therethrough which communicates with the opening 122, two of the hooking members 2 are respectively connected to the two respective first portions 213 of the two arms 12 respectively by hooking the engaging portion 24 to the aperture 125 corresponding thereto, the two hooks 22 of the two hooking members 2 are respectively hooked to the two respective apertures 125 of the two second portions 124.

5. The attachment member as claimed in claim 3, wherein each of the first and second portions 123, 124 has an aperture 125 defined therethrough which communicates with the opening 122, two of the hooking members 2 are respectively connected to the two respective second portions 214 of the two arms 12 respectively by hooking the engaging portion 24 to the aperture 125 corresponding thereto, the two hooks 22 of the two hooking members 2 are respectively hooked to the two respective apertures 125 of the two first portions 123.
